(19) United States
(12) Patent Application Publication
(10) Pub. No.: US 2026/0002485 A1
(43) Pub. Date: Jan. 1, 2026

(54) METHOD FOR EVALUATING AT LEAST ONE INJECTOR, CONTROL DEVICE FOR CARYING OUT SUCH A METHOD, AND INTERNAL COMBUSTION ENGINE ARANGEMENT INCLUDING SUCH A CONTROL DEVICE

(71) Applicant: Rolls-Royce Solutions GmbH, Friedrichshafen (DE)

(72) Inventors: Daniel Deussen, Salem (DE); Johannes Stöckler, Heiligenberg (DE); Christoph Hund, Tettnang (DE)

(73) Assignee: Rolls-Royce Solutions GmbH, Friedrichshafen (DE)

(21) Appl. No.: 19/317,672

(22) Filed: Sep. 3, 2025

Related U.S. Application Data
(63) Continuation of application No. PCT/EP2024/054320, filed on Feb. 20, 2024.

(30) Foreign Application Priority Data
Mar. 3, 2023 (DE) 10 2023 105 356.6
Feb. 20, 2024 (WO) PCT/EP2024/054320

(51) Int. Cl. F02D 41/24; F02D 29/06

(52) U.S. Cl. CPC F02D 41/2467; F02D 29/06; F02D 2250/24

(57) ABSTRACT

A method for evaluating at least one injector of an internal combustion engine includes the steps of: evaluating a plurality of the at least one injector of the internal combustion engine based on a power rating which is associated with an electric device that is operatively connected with the internal combustion engine.

### CROSS REFERENCE TO RELATED APPLICATIONS

This is a continuation of PCT application no. PCT/EP2024/054320, entitled “METHOD FOR EVALUATING AT LEAST ONE INJECTOR, CONTROL DEVICE FOR CARRYING OUT SUCH A METHOD, AND INTERNAL COMBUSTION ENGINE ASSEMBLY COMPRISING SUCH A CONTROL DEVICE”, filed Feb. 20, 2024, which is incorporated herein by reference. PCT application no. PCT/EP2024/054320 CLAIMS PRIORITY TO German patent application no. 10 2023 105 356.6, filed Mar. 3, 2023, which is incorporated herein by reference.

### BACKGROUND OF THE INVENTION

### 1. Field of the Invention

The present invention relates to internal combustion engines.

### 2. Description of the Related Art

Injectors which are provided for the delivery of fuel into an air path or into combustion chambers of an internal combustion engine can exhibit a volume spread or various faults or can completely fail. Thus, it is possible in particular that an injector tends to dispense too much or too little fuel due to deviating opening behavior. Or an injector may have a reduced or expanded opening dimension due to ageing or due to results of contamination and therefore dispenses too little or too much fuel. An injector can also be permanently open (continuous injection) or permanently closed (lack of injection) due to a defect. Such deviations or defects of individual injectors are generally difficult to identify and can only be determined with comparatively high effort. Thus, there is a need for a simple and reliable possibility to evaluate the injectors of an internal combustion engine.

What is needed in the art is a method for evaluating at least one injector of an internal combustion engine that has a plurality of injectors, a control device for an internal combustion engine arrangement designed to carry out such a method, and an internal combustion engine arrangement having such a control device, wherein the aforementioned disadvantages are at least reduced, optionally do not occur.

### SUMMARY OF THE INVENTION

The invention relates to a method for evaluating at least one injector in an internal combustion engine including a plurality of injectors, a control device for an internal combustion engine arrangement designed to carry out such a method, and an internal combustion engine arrangement including such a control device.

The present invention provides a method for evaluating at least one injector of an internal combustion engine having a plurality of injectors, wherein the injectors are evaluated on the basis of a power rating which is associated with an electric device that is operatively connected with the internal combustion engine. The power rating of the electric device optionally depends on the delivery behavior of the injectors, so that it can be utilized for the evaluation of the injectors. Moreover, the power rating of the electric device can be easily and precisely measured.

In the context of the current technical teaching, an evaluation of an injector is understood in that a deviation of the delivery behavior of the injector is determined relative to an expected or average delivery behavior—in particular of the remaining injectors of the internal combustion engine—and/or in that a fault of the injector is determined, in particular identified.

In the context of the present technical teaching, an injector is understood in particular as a device which is designed to deliver a fuel into an air path or combustion chamber of an internal combustion engine, in particular—in a volume controlled manner—in particular by controlling the injector with a predetermined opening time and predetermined duration, in particular by energizing the injector, in other words, in particular by applying an electric voltage or current. The injector can be designed to deliver a fuel that is liquid under standard conditions, in other words at 25° C. and 1013 mbar, or a fuel that is gaseous under standard conditions, in other words a fuel gas.

In the context of the present technical teaching, a power rating is understood in particular to be a value that is characteristic of a physical performance. A power rating assigned to the electric device is in particular characteristic for the physical performance of the electric device. In one arrangement, the power rating is in particular a torque value, in other words, in particular a value that is characteristic for a torque.

In the context of the present technical teaching, the fact that the electric device is operatively connected with the internal combustion engine means in particular, that the electric device receives the energy necessary or expended for its operation from the internal combustion engine. For this purpose, the electric device can be driven directly mechanically by the internal combustion engine, and/or can be connected with the internal combustion engine via an electrical operative connection in such a way that electric energy generated by way of the internal combustion engine can be supplied to the electric device via the electrical operative connection.

A further development of the invention provides that, in at least two operating states of the internal combustion engine, respectively assigned values of the power rating are determined, and wherein the injectors are evaluated based on a comparison of the values of the power rating assigned to the operating states. In this way, it can be advantageously concluded from the different values of the power rating that the internal combustion engine behaves differently in the at least two operating states, and an evaluation of the injectors can be derived.

In particular, the at least two operating states differ by the respectively assigned activation state of the injectors. This means, in particular, that in a first operating state of the at least two operating states a number and/or identity of activated injectors is different from a number and/or identity of the injectors activated in a second operating state of at least two operating states. An activated injector is understood in particular to be an injector that is controlled for the purpose of delivering fuel. On the other hand, a deactivated or switched off injector is understood to be an injector that is not controlled to deliver fuel. In particular, in a first operating state of the at least two operating states, all injectors of the internal combustion engine may be activated, wherein in a second operating state of the at least two operating states, a specific injector of the internal combustion engine may be deactivated, with all other injectors of the internal combustion engine being activated. It is possible that, in a third operating state of the at least two operating states another injector of the internal combustion engine is deactivated than in the second operating state, while all other injectors, including the injector that is deactivated in the second operating state, are activated. In particular, it is possible that for the valuation of an internal combustion engine which has n injectors, n+1 operating states are used, namely, an operating state in which all the injectors are activated, and n operating states in which in turn one of the injectors is deactivated, while the other injectors respectively are activated.

In particular, the injectors are evaluated by comparing the values of the power rating assigned to the operating states. In particular, the injectors are evaluated by comparing the values of the power rating assigned to the operating states with a deactivated injector with the value of the performance variable assigned to the operating state in which all injectors are activated. In particular, this method provides the advantage of a simple and reliable evaluation of the individual injectors.

A further development of the invention provides that a) the internal combustion engine is operated in a test state with activated injectors, wherein the injectors are each assigned the same, constant test injection volume of fuel, wherein a test value of the power rating is determined, wherein b) the internal combustion engine is operated successively in a plurality of shutdown states, wherein in each of the shutdown states one injector of the injectors assigned to the respective shutdown state is switched off—and in particular the other injectors are activated—wherein the remaining activated injectors are each assigned the same, constant test injection volume of fuel, and wherein, in the shutdown states, a measured value of the power rating associated with the respective shutdown state is determined, wherein c) the measured values are compared with the test value, wherein d) the injectors are evaluated on the basis of the comparison. In particular, a simple and reliable evaluation of the individual injectors is advantageously possible with this method. In particular, it follows that, if an injector is functioning without restriction and in accordance with its intended purpose, switching it off in a shutdown state should result in that the test injection volume required to operate the internal combustion engine is lacking in the shutdown state compared to the test state. This, in turn, should result in an expected change in the power rating in the shutdown state relative to the test state. If the observed change in power rating deviates from the expected change, it can be concluded that the injector is not actually delivering the test injection volume, but is delivering an injection volume deviating from the latter, so that it is possible to evaluate the behavior of the injector. In particular, it can be concluded based on the actual change in power rating whether the injector is delivering more or less fuel than the test injection volume; if there is no change in power rating, it can also be concluded that the injector is injecting continuously or is not opening. However, it is not possible to distinguish between continuous injection and a complete lack of opening (no injection), as in both cases there is no change in the power rating since the injector behaves in the same way regardless of whether it is activated or deactivated.

In the context of the present technical teaching, assigning an injection volume to an injector means in particular that the injector is controlled in such a way that it injects the assigned injection volume as intended, that is, as long as there is no deviation or fault.

In particular, in step b), the injectors of the internal combustion engine are switched off in turn, wherein in each shutdown state a different injector of the injectors is deactivated, while all other injectors are activated. In particular, in this way, all injectors are iterated in step b).

In particular, the test state is a first operating state of the at least two operating states. In particular, in the test state all injectors of the internal combustion engine are activated. The test value is determined in particular as a first value of the assigned values.

The test state is in particular a stationary test state. This means, in particular, that the internal combustion engine is operated in the test state for a predetermined time interval at a constant test speed within a predetermined speed tolerance range. In one arrangement, the test speed is 1800 min⁻¹.

A constant test injection volume is understood, in particular, to be an injection volume which is defined and constant per injection, in other words for each injection event and for each injector. In particular, the test injection volume is a defined fuel mass or a defined fuel volume. In one arrangement, the test injection volume is 50 mm³ of fuel, in particular 50 mm³ of diesel (based on standard conditions).

In particular, the shutdown states are further operating states of the at least two operating states. In particular, the measured values of the power rating assigned to the shutdown states are determined as additional assigned values of the power rating.

In particular, each of the shutdown states is a stationary shutdown state. This means in particular that, in the respective shutdown state, the internal combustion engine is driven over a predetermined time interval at a constant shutdown speed within a predetermined speed tolerance range. In particular, the shutdown speed in one embodiment is identical to the test speed, in particular equal to a test speed. In one arrangement, the shutdown speed is 1800 min⁻¹. In particular, the test speed is 1800 min⁻¹. Thus, the internal combustion engine is operated in particular at the same speed in the shutdown states as in the test state, in particular at the test speed.

A further development of the invention provides that a device is used as the electric device that is selected from a group consisting of an electric machine which is drive-effectively connected with the internal combustion engine, an electric consumer, and a combination thereof.

In one embodiment, the electric machine that is drive-effectively connected to the internal combustion engine is a generator.

In one embodiment at least one electric consumer is electrically connected with an electric machine designed as a generator, wherein the electric machine in turn is drive-effectively connected with the internal combustion engine. The at least one electric consumer is in particular a cooling fan, in particular a cooling fan provided for cooling the air in a cooling circuit of the internal combustion engine. In one arrangement, two electric consumers which are designed specifically as cooling fans are electrically connected with the electric machine.

A further development of the invention provides that an electric cooling fan is used as the electric device.

A further development of the invention provides that a value used as the power rating is selected from a group consisting of a generator torque, a consumer speed of an electric consumer, and a combination thereof. These values are especially suitable for determining the power rating related to at least one electric device or a proportion of power of the internal combustion engine related to it.

The generator torque is in particular the torque of the electric machine designed as a generator, which is drive-effectively connected with the internal combustion engine. The consumer speed is, in particular, the speed of the electric device designed as an electric consumer or including an electric consumer, in particular the speed of a cooling fan. The speed of a cooling fan is directly linked to its power consumption and thus also to the proportion of power generated by the internal combustion engine that is related to the cooling fan. If an electric machine that is designed as a generator and is drive-effectively connected with the internal combustion engine and at least one electric consumer that is connected to the electric machine are provided, and if the generator torque is measured, it is easily possible to consider the electric consumer as the electric device and to determine the torque component of the generator torque attributable to the electric consumer as the power rating by subtracting the torque components of the generator torque attributable to potentially other electric consumers. For this purpose, the power consumption of the other electric consumers can be easily recorded by a control device, and the corresponding torque components can be determined.

A further development of the invention provides that in at least one step selected from steps a) and b), optionally in both steps a) and b), the internal combustion engine is operated at the constant test speed above an idle speed, wherein the test injection volume is adjusted by varying an electric load of the electric device. Advantageously, the test injection volume corresponds to a specific energy volume, so that the sum of the test injection volumes theoretically delivered by the injectors at the constant test speed corresponds to a specific test performance. If at least one of the injectors delivers a fuel volume that differs from the test fuel volume, this corresponds again with an output of the internal combustion engine that at the constant test speed differs from the determined test output. By varying the electric load of the electric device, the performance of the internal combustion engine can be varied at the constant test speed, and the control of the injectors can be adjusted in a control device of the internal combustion engine to deliver the test fuel volume. The actual performance can then be determined via the electric load of the electric device and can be used to evaluate the injectors. In particular, the control device maintains the engine speed constant at the test speed by appropriately adjusting the injection volume assigned to the injectors by the control device depending on the load. Accordingly, by varying the electric load, the injection volume assigned to the injectors can be adjusted to the test injection volume in the control device. In one arrangement, the idle speed is 1000 min⁻¹.

Originating from a predetermined starting load value the electric load of the electric device is increased, in particular in increments or continuously until the test injection volume is set. In one arrangement, a speed of the electric device, in particular the consumer speed of the electric device, in particular a cooling fan speed of a cooling fan, is varied as the electric load. In particular, the consumer speed is increased in particular incrementally or continuously, originating from a consumer speed starting value.

Alternatively, it is provided in the at least one step selected from steps a) and b), optionally in both steps a) and b), that the constant test injection volume is allocated to the injectors, wherein the test speed is adjusted by varying the electric load of the electric device. This corresponds to a procedure that is reversed relative to the previously explained procedure, which advantageously leads to the same findings.

In one arrangement the internal combustion engine is driven at constant test speed in step a), wherein the test injection volume is adjusted by varying the electric load of the electric device. In step b), the constant test injection volume is assigned to the injectors, wherein the test speed is adjusted by varying the electric load of the electric device.

Alternatively, in the at least one step selected from steps a) and b), optionally in both steps a) and b), it is provided that the test injection volume and the test speed are adjusted by—at least temporarily jointly—variation of the electric load of the electric device on the one hand and the injection volume that is assigned to the injectors on the other hand.

A further development of the invention provides that—in particular after step a) and prior to step b)—the test value is compared with at least one reference test value. This advantageously allows, in particular, an evaluation of the internal combustion engine as a whole. It can thus be determined, in particular, whether the internal combustion engine provides average, below-average, or above-average output or torque.

In one arrangement, the comparison test value is an individual value from a comparison internal combustion engine, in particular with known fully functional injectors, which additionally exhibit a low volume spread within a predetermined spread range. Alternatively, or in addition, the comparison test value is an average value obtained from the measurement of a plurality of internal combustion engines.

In one embodiment, steps b) to d) are omitted if a test value deviation of the test value from the at least one comparative test value exceeds a predetermined limit. In particular, the magnitude of the test value deviation is compared with the predetermined limit. If the test value deviation, in particular its magnitude, exceeds the predetermined limit, it is concluded that the internal combustion engine has a serious defect, necessitating further investigations beyond the evaluation of the injectors.

Steps b) to d) are essentially only carried out, if the test value deviation—in particular, the magnitude thereof—is only as great as the predetermined limit.

A further development of the invention provides that, in step c), the measured values are compared with the test value in that for each measured value a test difference to the test value is calculated. In particular, the injectors are evaluated based on the assigned test differences. In particular, the respectively assigned test difference can be used to assess whether an injector is delivering less than the test injection volume or more than the test injection volume. The test differences are always either zero or—depending on the definition of the test differences—always have the same sign, which is always negative when the test value is subtracted from the respective measured value or, conversely is always positive when the respective measured value is subtracted from the test value. At best, the respective measured value is as great as the test value, since the power rating can decrease at best, but not increase, when an injector is deactivated, because the injector can at most deliver a lower injection volume when deactivated, not, however, a greater injection volume, than when activated. However, it is possible that no difference occurs between the activated and deactivated states of the injector if it either injects continuously or no longer opens. In this case, the assigned test difference is zero.

In one embodiment, the test differences are always compared with a predetermined first threshold value and a predetermined second threshold value which is different from the first threshold value, wherein the injectors are evaluated based on the comparison of the test differences with the predetermined first and second threshold values. To simplify the method, in particular, the magnitudes of the test differences are compared in one arrangement with the threshold values. This is easily possible since the test differences always have an identical sign. To simplify the presentation, it is therefore assumed in the following, without loss of generality, that both the test differences and the threshold values are positive.

In one arrangement in particular, the second threshold value is greater than the first threshold value.

In one embodiment, the first threshold value and the second threshold value are empirically determined values, which are determined, in particular, in the field of application on a plurality of internal combustion engines or through test bench tests. It should be noted that the test differences and the threshold values are values of the power rating that cannot easily be assigned to analytically determined delivery volumes. Therefore, the empirical determination of the threshold values represents a pragmatic as well as a functional design.

If the test difference assigned to an injector is smaller than the first, lower threshold value, it is advantageously concluded in one embodiment that the injector delivers less than the test injection volume in spite of activation with this volume. The contribution of the injector to the test value is therefore obviously lower than the contribution assigned to the test injection volume. If, on the other hand, the test difference is greater than the first threshold value but less than the second, larger threshold value, it is concluded that the injector delivers the test injection volume within a predetermined tolerance defined by the distance between the two threshold values. The contribution of the injector to the test value thus corresponds to the contribution that is predetermined by the test injection volume. If, on the other hand, the test difference is greater than the second threshold value, it is concluded that the injector delivers more than the test injection volume despite being controlled by the test injection volume. Thus, the contribution of the injector to the test value is obviously greater than the contribution predetermined by the test injection volume. If, in contrast, the test difference is zero or is within a predetermined zero tolerance range, it can only be concluded that deactivation of the injector does not affect its behavior, which can have two reasons: on the one hand, it is possible that the injector is injecting continuously; on the other hand, it is possible that the injector is permanently closed.

A further development of the invention provides that a difference average value of the test differences is calculated, wherein a difference deviation from the difference average value is calculated for each test difference, wherein the injectors are additionally evaluated based on the difference deviations. This advantageously makes it possible to evaluate the injectors collectively as a whole.

In one embodiment, a mean is calculated as the difference average value. In another embodiment, an arithmetic mean is calculated as the difference average value. In yet another embodiment, a geometric mean is calculated as the difference average value.

In one embodiment, a check is performed to determine whether the respective difference deviation of the injectors is within a predetermined difference tolerance range. If this is the case for an injector, the injector is rated as being acceptable, provided that the test difference assigned to the injector is not zero or within the zero tolerance range. If the test deviation assigned to the injector is within the zero tolerance range or outside the deviation tolerance range, or if the test deviation is zero, the injector is rated as defective.

The invention also includes a computer program including commands that initiate a computing device, in particular a control device for controlling an internal combustion engine arrangement, to execute the method according to the invention or a method according to one or more of the previously described embodiments, if the computer program is running on the computing device.

The invention also includes a machine-readable storage device on which the inventive computer program is stored.

The present invention also provides a control device for an internal combustion engine arrangement which is designed to carry out a method according to the invention or a method according to one or a number of the previously described embodiments. In connection with the control device, the advantages result in particular that were previously explained in connection with the method.

In particular, the control device has a first interface for operative connection with the internal combustion engine, in particular with the injectors of the latter. In particular, the control device also has a second interface for operative connection with the electric device.

The present invention also provides an internal combustion engine arrangement including an internal combustion engine, wherein the internal combustion engine has a plurality of injectors. The internal combustion engine arrangement further includes an electric device that is operatively connected with the internal combustion engine and an inventive control device or a control device according to one or a number of the previously described embodiments. In connection with the internal combustion engine arrangement, the advantages that result in particular were previously explained in connection with the method or the control device are particularly evident.

In particular, the internal combustion engine arrangement has at least one feature, in particular a combination of features, which were previously explained explicitly or implicitly in the presentation of the method in connection with components of the internal combustion engine arrangement.

In particular, the control device is operatively connected with the internal combustion engine, in particular with the injectors of the latter, and is designed to control the internal combustion engine, in particular to assign a respective injection volume to the injectors. In particular, the control device is also operatively connected to the electric device and is designed to control the electric device.

A further development of the invention provides that the electric device includes an electric machine that is drive-effectively connected with the internal combustion engine, and a consumer that is electrically connected with the electric machine, wherein the control device is designed in particular for variation, especially adjustment of an electric load, in particular of the consumer speed of the electric consumer. For this purpose, the control device is operatively connected with the electric consumer.

In one arrangement, the internal combustion engine is designed as a reciprocating piston engine, in particular as a diesel engine.

The invention also includes a motor vehicle that has an internal combustion engine arrangement according to the invention or an internal combustion engine arrangement according to one or a number of the previously described embodiments.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a schematic representation of a design example of an internal combustion engine arrangement with a design example of a control device;

FIG. 2 is a schematic representation of a first part of a design example of a method for evaluating injectors of the internal combustion engine of the internal combustion engine arrangement according to FIG. 1;

FIG. 3 is a schematic representation of a first design example of a second part of the method according to FIG. 2;

FIG. 4 is a schematic representation of a second design example of the second part of the method according to FIG. 2; and

FIG. 5 is a schematic representation of a third part of the method according to FIGS. 2 to 4.

Corresponding reference characters indicate corresponding parts throughout the several views. The exemplifications set out herein illustrate embodiment of the invention, and such exemplifications are not to be construed as limiting the scope of the invention in any manner.

### DETAILED DESCRIPTION OF THE INVENTION

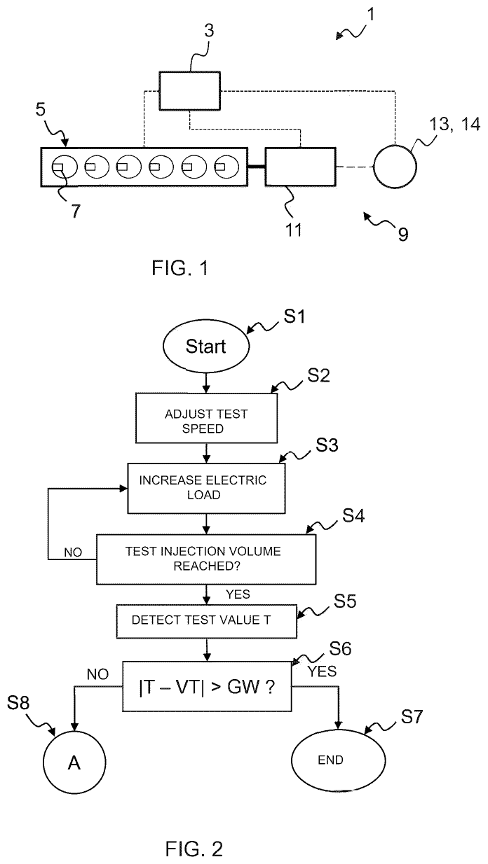

FIG. 1 is a schematic representation of a design example of an internal combustion engine arrangement 1 with a design example of a control device 3.

Internal combustion engine arrangement 1 has a combustion engine 5 with a plurality of injectors 7, only one of which is indicated with the applicable reference number. Moreover, internal combustion engine arrangement 1 has an electric device 9 that is operatively connected to internal combustion engine 5. Control device 3 is operatively connected, in particular, with internal combustion engine 5, in particular with injectors 7, and is designed to control internal combustion engine 5, in particular to assign a respective injection volume to the injectors 7. In particular, control device 3 is also operatively connected with electric device 9 and is designed to control electric device 9.

Electric device 9 optionally includes an electric machine 11 designed as a generator, that is drive-effectively connected with internal combustion engine 5, and at least one electric consumer 13 that is electrically connected to electric machine 11, which is optionally designed as a cooling fan 14, in particular as a cooling fan 14 provided for air cooling of a cooling circuit in internal combustion engine 5. Internal combustion engine arrangement 1 optionally includes two such cooling fans 14. Control device 3 is designed, in particular, to vary, in particular adjust, an electric load, in particular a consumer speed, of the at least one electric consumer 13. Control device 3 is optionally operatively connected with electric machine 11 or to the electric load 13. In particular, it is possible for control device 3 to be operatively connected with electric machine 11 on the one hand and to the electric load 13 on the other. Optionally, control device 3 is designed to detect a generator torque of electric machine 11 as a power variable. Alternatively, or in addition, control device 3 is designed to detect the rotational speed of electric load 13 as a power rating.

Internal combustion engine 5 is designed as a reciprocating piston engine, in particular as a diesel engine.

FIG. 2 is a schematic representation of a first part of a design example of a method for evaluating injectors of internal combustion engine 5 of internal combustion engine arrangement 1 according to FIG. 1.

Identical and functionally identical elements are provided with the same reference symbols in all figures, so that reference can be made to the preceding description in each case.

Within the scope of the method, injectors 7 are evaluated based on the power rating assigned to electrical device 9. In particular, the respective values of the power variable are determined in at least two operating states of internal combustion engine 5. Injectors 7 are evaluated by way of a comparison of the power rating values assigned to the operating states. The at least two operating states differ therein, in particular, in a respectively assigned activation state of injectors 7. In particular, injectors 7 are evaluated together based on a comparison of the power rating values assigned to the operating states. In particular, injectors 7 are evaluated by comparing the power rating values assigned to operating states with one deactivated injector 7 respectively, with a power rating value assigned to an operating state in which all injectors 7 are activated.

Specifically, in the design example shown in FIG. 2, the process is started in a first step S1. In particular, internal combustion engine arrangement 1 is initially operated at an idle speed of internal combustion engine 1 and an idle consumer speed of electric consumer 13, that is designed in particular as a cooling fan 14. In one arrangement, the idle consumer speed is 600 min⁻¹. If, however, the cooling requirement of internal combustion engine 5 is already higher at idle, electric consumer 13 can also be operated at a higher consumer speed. An operator of internal combustion engine arrangement 1 can now optionally deactivate an automatic control of the internal combustion engine 5. In a second step S2, the speed of internal combustion engine 1 is increased to the test speed, in particular without increasing the electric load, in other words, in particular, with the consumer speed maintained constant. In the following process steps, the test speed is constantly regulated by control device 3 by allocating a suitable injection volume to injectors 7. The electric load is optionally increased to a starting load value, for which, in particular, the consumer speed is increased to a consumer speed starting value, for example, to 1500 min⁻¹.

In a third step S3, the electric load, in particular the consumer speed, is increased continuously or incrementally, wherein parallel thereto, or after each increase, it is checked in a fourth step S4 whether the test injection volume has been reached. Increasing the electric load simultaneously increases the torque to be generated by internal combustion engine 5, so that control device 3 correspondingly increases the injection volume assigned to injectors 7. This continues until it is determined in fourth step S4 that control device 3 allocates the test injection volume to each injector 7 respectively, wherein internal combustion engine 5 is being operated, in particular, in a test state.

If this is the case, an optional check is performed to determine whether the operation of internal combustion engine arrangement 1 is steady-state, in particular by checking whether internal combustion engine 5 is running at the test speed within a predetermined speed tolerance range for a predetermined period of time. Internal combustion engine 5 is thus operated in particular in a stationary test state.

In a fifth step S5, a test value T of the power variable is measured. A generator torque and/or the consumer speed can be used in particular as the power rating.

In a sixth step S6, test value T is compared with a comparative test value VT, specifically by calculating a test value deviation as the amount of a difference between test value T and comparative test value VT. Comparative test value VT can be an individual value of a comparison internal combustion engine, specifically with known fully functional injectors, which in particular, exhibit in addition a small volume spread within a predetermined spread range, or an average value obtained from the measurement of a plurality of internal combustion engines.

If the test value deviation exceeds a predetermined limit value GW in sixth step S6, it is concluded that internal combustion engine 5 has a serious fault, and the method is terminated in seventh step S7. If, however, the test value deviation does not exceed the predetermined limit value GW, the method is continued in eighth step S8 at a first jump marker A.

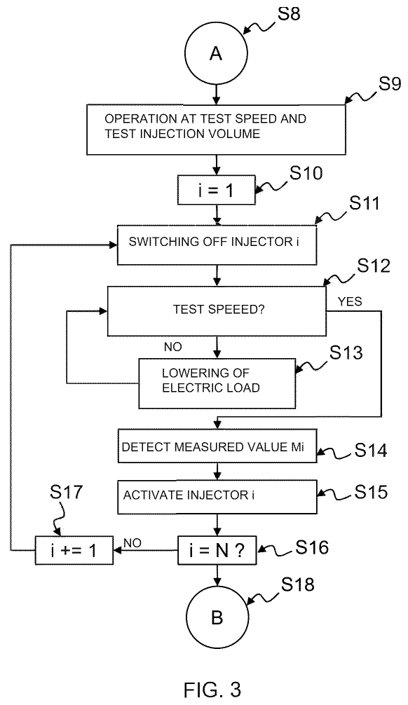

FIG. 3 is a schematic representation of a first design example of a second part of the method.

The process continues hereby in eighth step S8 at first jump marker A. In ninth step S9, the operation of internal combustion engine arrangement 1 is continued at the test speed and the test injection volume allocated by control device 3, as indicated for internal combustion engine arrangement 1 from the previously performed method steps. In particular, electrical consumer 13 also still has the most recently set consumer speed.

In tenth step S10, an index i is initialized with 1.

In eleventh step S11, the specific injector 7 to which the current index i is assigned is switched off, wherein control device 3 continues to assign the test injection volume to the remaining, activated injectors 7. Internal combustion engine 5 is thus operated in a shutdown mode. If switched off injector i is functional—meaning, it has neither continuous injection nor a permanently closed state—the speed of the internal combustion engine 5 collapses as a result, since without the contribution of the switched off injector i it can no longer provide the power required by electric consumer 13. Accordingly, it is checked in twelfth step S12 whether internal combustion engine is running at the test speed; if this is not the case, the electric load is reduced in thirteenth step S13, in particular by reducing the consumer speed. Steps S12 and S13 are iterated until it is determined in twelfth step S12 that internal combustion engine 5 is running at the test speed.

If it is determined in twelfth step S12 that internal combustion engine 5 is operating at the test speed, a measured value Mᵢ of the power variable assigned to the current injector i is recorded in a fourteenth step S14. Then, in a fifteenth step S15, the current injector i is reactivated.

Prior to recording measured value Mᵢ, it is checked as an option whether the operation of internal combustion engine arrangement 1 is steady-state. For this purpose, it is specifically checked whether internal combustion engine 5 runs at the test speed for a predetermined period of time within the predetermined speed tolerance range. Internal combustion engine 5 is thus operated, in particular, in a stationary shutdown state.

Subsequently, it is checked in a sixteenth step S16, whether the current value of index i corresponds to the total number N of injectors 7 of internal combustion engine 5. If this is not the case, index i is incremented in seventeenth step S17, and the method continues in the eleventh step S11 for a next injector 7. If, however, it is determined in the sixteenth step S16 that index i already has the value N, the method continues in an eighteenth step S18 at a second jump marker B.

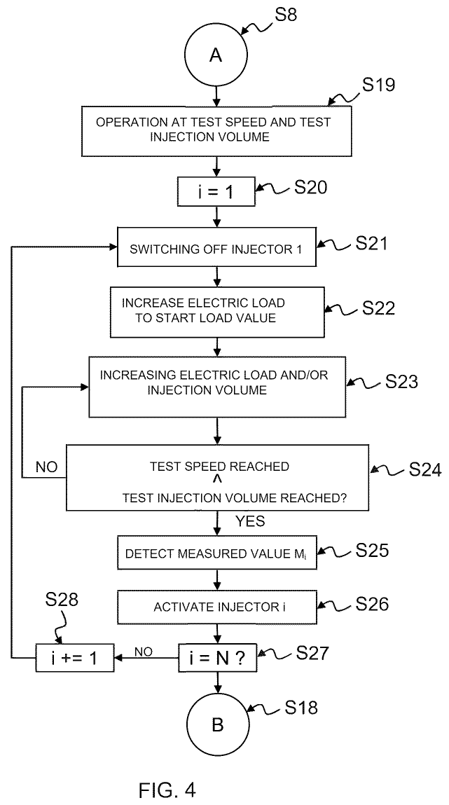

FIG. 4 is a schematic representation of a second design example of the second part of the method, which is an alternative to the first design example according to FIG. 3.

The method is again continued in eighth step S8 at the first jump marker A. In nineteenth step S19, the operator of internal combustion engine arrangement 1 first activates the automatic control of internal combustion engine 5, so that internal combustion engine 5 operates at idle speed and, in particular, that electrical consumer 13 operates at the idle consumer speed. If, however, the cooling requirement of internal combustion engine 5 is higher during idle, electrical consumer 13, which is designed specifically as a cooling fan 14, can also be operated at a higher consumer speed.

Then, in twentieth step S20, index i is initialized with value 1.

In step twenty-first S21, the specific injector 7 to which the current index i is assigned is switched off. Internal combustion engine 5 is thus operated in a shutdown state. In twenty-second step S22, the electric load is increased to the starting load value, which means, in particular, that the consumer speed is increased to the consumer speed starting value.

In twenty-third step S23, the electric load, that is, in particular the consumer speed and/or the injection volume assigned by control device 3 to the specific injectors 7 which are not switched off are increased until it is determined in twenty-fourth step S24 that both internal combustion engine 5 is running at the test speed and control device 3 is assigning the test injection quantity respectively to the specific injectors 7 which are not switched off. It is therein possible, in particular, to initially increase the electric load and the injection volume in parallel until the test injection volume is reached, wherein the electric load is subsequently varied further until also the test speed is reached.

Then, in twenty-fifth step S25, the measured value Mᵢ of the power rating that is assigned to the current injector i is recorded.

Prior to recording measured value Mᵢ, an optional check is conducted as to whether the operation of internal combustion engine arrangement 1 is stationary, wherein it is checked, in particular, whether internal combustion engine 5 runs at the test speed for a predetermined period of time within the predetermined speed tolerance range. Internal combustion engine 5 is thus operated, in particular, in a stationary shutdown mode.

In step S26, the current injector i is reactivated.

Subsequently, in twenty-seventh step S27, it is checked whether the current value of index i corresponds to the total number N of injectors 7 of internal combustion engine 5. If this is not the case, index i is incremented in twenty-eighth step S28, and the method continues in twenty-first step S21 for a next injector 7. If, in contrast it is determined in twenty-seventh step S27 that index i already has the value N, the method continues in eighteenth step S18 at second jump marker B15.

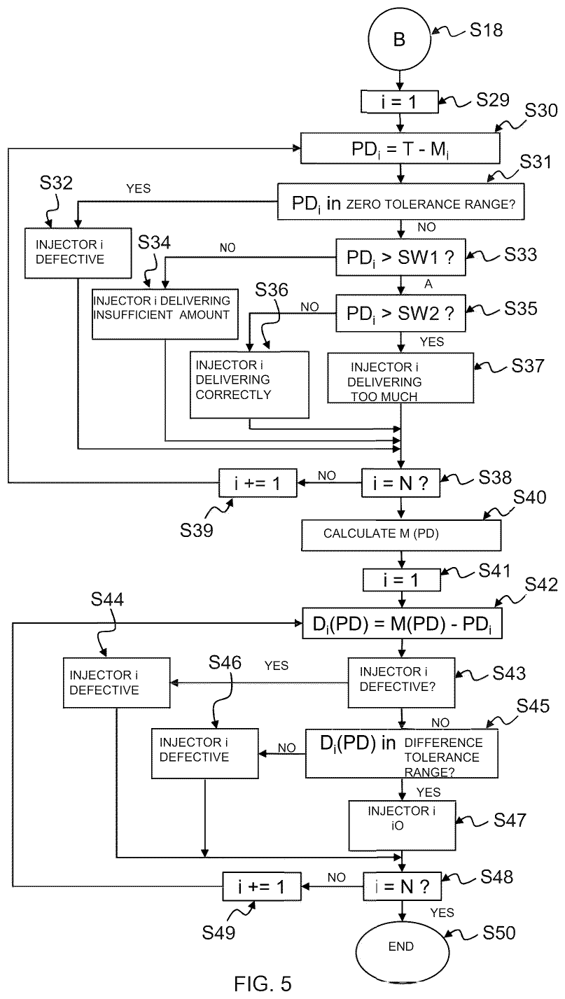

FIG. 5 is a schematic representation of a third part of the method. In the third part of the method, measured values Mᵢ are compared with test value T by calculating a test difference PDᵢto test value T for each measured value Mᵢ. Injectors 7 are evaluated in particular based on the assigned test differences PDᵢ.

For this, the method is continued in eighteenth step S18 at the second jump marker B. In step S29, index I is again initialized with value 1.

In thirtieth step S30, the test difference PDᵢ that is assigned to the specific injector 7 to which the current index i is assigned is calculated by subtracting the assigned measured value Mᵢ from test value T. The thus defined test difference is either zero or positive, since measured value Mᵢ is at most as great as test value T.

In thirty-first step S31, it is checked whether the test difference PDᵢ that is assigned to current injector i is within a zero tolerance range, in other words, within a predetermined interval [0,u] with an upper limit u>0, wherein with respect to a first threshold value SWI, the following optionally applies: u<<SW1.

If, in thirty-first step S31, it is determined that the test difference PDᵢ is within a zero tolerance range, then it is determined in thirty-second step S32, that is, stored here and in the following, in particular for the current injector i, that the injector i is defective.

If, in contrast it is determined in thirty-first step S31 that the test difference PD₁ is not within the zero test range, it is checked in thirty-third step S33 whether the test difference PD₁ is greater than first threshold value SW1. If this is not the case it is established in thirty-fourth step S34 that the current injector i in fact delivers an injection volume that is lower than the test injection volume, for the delivery of which it is controlled by control device 3.

If, in contrast it is determined in thirty-third step S33 that the test difference PDi is greater than first threshold value SWI, it is checked in thirty-fifth step S35 whether the test difference PDi is greater than a second threshold value SW2, for which SW2>SWI applies. If this is not the case, it is determined in a thirty-sixth step S36 that the current injector i actually delivers the test injection volume, for the delivery of which it is controlled by control device 3.

If, in contrast it is determined in thirty-fifth step S35 that the test difference PDi is greater than second threshold value SW2, then it is determined in thirty-seventh step S37 that the current injector i actually delivers an injection volume that is greater than the test injection volume, for the delivery of which it is controlled by control device 3.

Subsequently it is checked in thirty-eighth step S38 whether the current value of index i corresponds to the total number N of injectors 7 of internal combustion engine 5. If this is not the case, index i is incremented in thirty-ninth step S39, and the process is continued in thirtieth step S30 for a next injector 7.

If, in contrast it is determined in thirty-eighth step S38 that the index i already has the value N, the process continues in fortieth step S40, in which a difference mean value M(PD) is calculated across all test differences PDᵢ assigned to the injectors. In particular, a median, an arithmetic mean, or a geometric mean can be calculated as the difference average value.

In forty-first step S41, the index i is again initialized with value 1.

In forty-second step S42, a difference deviation Dᵢ(PD) that is assigned to the specific injector 7 to which the current index i is assigned is calculated by subtracting the assigned test difference PDᵢ from difference mean value M(PD).

In forty-third step S43, a check is conducted as to whether current injector i has already been marked as defective in thirty-second step S32 because the test difference PDᵢ assigned to it is within the zero tolerance range. If this is the case, injector i is again confirmed as defective in forty-fourth step S44, or the marking as being defective is simply retained.

If, however, it is determined in forty-third step S43 that the current injector i is not marked as defective, it is checked in forty-fifth step S45 whether the differential deviation Di (PD) is within a predetermined differential tolerance range. If this is not the case, it is determined in forty-sixth step S46 that injector i is defective. If, however, it is determined in forty-fifth step S45 that the differential deviation Dᵢ(PD) is within the predetermined differential tolerance range, the injector i is assessed as being OK in forty-seventh step S47.

Subsequently, in forty-eighth step S48, it is checked whether the current value of index i corresponds to the total number N of injectors 7 of internal combustion engine 5. If this is not the case, index i is incremented in forty-ninth step S49, and the process is continued in forty-second step S42 for next injector 7. If, on the other hand, it is determined in forty-eighth step S48 that index i already has the value N, the process is terminated in fiftieth step S50.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A method for evaluating at least one injector of an internal combustion engine, the method comprising the steps of:
evaluating a plurality of the at least one injector of the internal combustion engine based on a power rating which is associated with an electric device that is operatively connected with the internal combustion engine.

2. The method according to claim 1, wherein the plurality of the at least one injector is a plurality of injectors, wherein, in least two operating states of the internal combustion engine, a plurality of values of the power rating assigned respectively to the at least two operating states are determined, and wherein the plurality of injectors are evaluated based on a comparison of the plurality of values of the power rating assigned to the at least two operating states.

3. The method according to claim 1, wherein the plurality of the at least one injector is a plurality of injectors, wherein method further includes the steps of:
(a) operating the internal combustion engine in a test state with activated ones of the plurality of injectors, wherein the plurality of injectors are each assigned a same, constant test injection volume of fuel, wherein a test value of the power rating is determined;
(b) operating the internal combustion engine successively in a plurality of shutdown states, wherein, in each of the plurality of shutdown states, a respective one of the plurality of injectors assigned to a respective one of the plurality of shutdown states is switched off, wherein remaining ones of the plurality of injectors are respectively assigned the same, constant test injection volume of fuel, wherein, in the plurality of shutdown states, a measured value of the power rating associated with a respective one of the plurality of shutdown states is determined; (c) comparing a plurality of measured values—including the measured value of the power rating—with the test value; and
(d) evaluating the plurality of injectors based on the step of comparing.

4. The method according to claim 3, wherein the electric device is selected from a group consisting of: an electric machine, which is drive-effectively connected with the internal combustion engine; an electric consumer; and a combination thereof.

5. The method according to claim 3, wherein the electric device is an electric cooling fan.

6. The method according to claim 3, wherein a respective one of the plurality of values is used as the power rating which is selected from a group consisting of: a generator torque; a consumer speed of an electric consumer; and a combination thereof.

7. The method according to claim 3, wherein, in at least one of steps (a) and step (b),
(i) the internal combustion engine is operated at a constant test speed above an idle speed, wherein a test injection volume is adjusted by varying an electric load of the electric device; or
(ii) the plurality of injectors are allocated the constant test injection volume, wherein a test speed is adjusted by variation of an electric load of the electric device.

8. The method according to claim 3, wherein, in both steps (a) and (b),
(i) the internal combustion engine is operated at a constant test speed above an idle speed, wherein a test injection volume is adjusted by varying an electric load of the electric device; or
(ii) the plurality of injectors are allocated the constant test injection volume, wherein a test speed is adjusted by variation of an electric load of the electric device.

9. The method according to claim 3, wherein the test value of the power rating is compared with at least one comparative test value.

10. The method according to claim 9, wherein steps (b), (c), and (d) are omitted if a test value deviation of the test value from the at least one comparative test value exceeds a predetermined limit.

11. The method according to claim 3, wherein, in step (c), the plurality of measured values are compared with the test value in that, for each one of the plurality of measured values, a test difference to the test value is calculated.

12. The method according to claim 11, wherein a plurality of test differences are calculated, wherein the plurality of test differences are always compared with a predetermined first threshold value and a predetermined second threshold value which is different from the predetermined first threshold value, wherein the plurality of injectors are evaluated based on a comparison of the plurality of test differences with the predetermined first threshold value and the predetermined second threshold value.

13. The method according to claim 11, wherein a difference average value of the plurality of test differences is calculated, wherein a difference deviation from the difference average value is calculated for each one of the plurality of test differences thereby resulting in a plurality of difference deviations, wherein the plurality of injectors are additionally evaluated based on the plurality of difference deviations.

14. A control device of an internal combustion engine arrangement, the control device comprising:
the control device, which is configured for carrying out a method for evaluating at least one injector of the internal combustion engine, the method including the steps of:
evaluating a plurality of the at least one injector of the internal combustion engine based on a power rating which is associated with an electric device that is operatively connected with the internal combustion engine.

15. An internal combustion engine arrangement, comprising:
an internal combustion engine including a plurality of injectors;
an electric device that is operatively connected with the internal combustion engine; and
a control device, which is configured for carrying out a method for evaluating at least one of the plurality of injectors of the internal combustion engine, the method including the steps of evaluating the plurality of injectors of the internal combustion engine based on a power rating which is associated with the electric device that is operatively connected with the internal combustion engine.

16. The internal combustion engine arrangement according to claim 15, wherein the electric device includes an electric machine and an electric consumer, wherein the electric machine is drive-effectively connected with the internal combustion engine, and wherein the electric consumer is electrically connected with the electric machine.

17. The internal combustion engine arrangement according to claim 16, wherein the control device is arranged for a variation of an electric load of the electric consumer.
